(19) United States
(12) Patent Application Publication
(10) Pub. No.: US 2012/0064496 A1
(43) Pub. Date: Mar. 15, 2012

(54) Emergency Cardiac Arrhythmia Identifying Device and System

(76) Inventor: Gary Krause, Racine, WI (US)

(21) Appl. No.: 12/880,544

(22) Filed: Sep. 13, 2010

(51) Int. Cl. G09B 29/04

(52) U.S. Cl. 434/262

(57) ABSTRACT

The present invention is an emergency cardiac arrhythmia identifying device and system which can be implemented in a non-electronic visual media or in an electronic format capable of communicating ECG and EKG data observed by medical personnel over a local area network. A healthcare professional may visually identify an arrhythmia, record the occurrence of the arrhythmia in a specific patient file, communicate information to other healthcare professionals and view treatment protocols in a matter of seconds.

### FIELD OF INVENTION

The present invention relates to the field of medical devices, and more specifically to a visual device for rapidly identifying cardiac arrhythmias.

### BRIEF DESCRIPTION OF THE DRAWINGS

FIG. 1 is a closed view of an exemplary embodiment of an emergency cardiac arrhythmia identifying device.

FIG. 2 is a half open front view of an exemplary embodiment of an emergency cardiac arrhythmia identifying device.

FIG. 3 is a full open front view of an exemplary embodiment of an emergency cardiac arrhythmia identifying device.

FIG. 4 is a full open back view of an exemplary embodiment of an emergency cardiac arrhythmia identifying device.

FIG. 5 is a closed view of an exemplary embodiment of an emergency cardiac arrhythmia identifying device.

FIG. 6 illustrates one embodiment of an emergency cardiac arrhythmia identifying device and system.

FIG. 7 illustrates one embodiment of an emergency cardiac arrhythmia identifying device and system implemented on a local area network.

### GLOSSARY

As used herein, the term “artifact” is a term known in the art which refers to data in an ECG and EKG record or image which falsely reflects an arrhythmia. For example, artifacts may reflect phenomena resulting from normal patient activity, electrical interference, loose electrodes, etc.

As used herein, the term “ECG/EKG arrhythmia image” refers to an illustration or depiction of a heart beat or cardiac arrhythmia with ideal exemplary characteristics of the heartbeat or cardiac arrhythmia.

As used herein, the term “EKG strip” or “ECG strip” means any image produced by an electrocardiograph machine or instrument.

As used herein, the term “key characteristic” means those essential characteristics of a cardiac arrhythmia that are necessary for its identification.

As used herein, the term “order of treatment priority” means the order in which cardiac arrhythmias should be treated based on risk posed to a patient.

As used herein, the term “sufficient time duration” refers to the time needed in order to establish a cardiac arrhythmia pattern at a characteristic heart rate. For most cardiac arrhythmias, a time duration of 4 to 8 seconds is sufficient to establish a pattern.

As used hereing, the term “surface” refers to any stationary or mobile surface a user may removably or permanently secure a visual cuing device to. Surfaces may include, but are not limited to, tables, desks, emergency crash carts, nurses' stations, ECG/EKG devices, walls, doors, examination tables and patient beds.

As used herein, the term “visual cuing device” means a rigid display with illustrations depicting ideal cardiac rhythms and arrhythmias adapted to help a user quickly and easily compare the illustrations to actual cardiac rhythms and arrhythmias in a medical care setting.

### BACKGROUND

Electrocardiography (ECG or EKG) is a representation of the activity of the heart captured and externally recorded by skin electrodes on an electrocardiographic device. Electrocardiography is displayed on computer screens and, equally commonly, on paper printouts that can be torn off of an electrocardiography machine (which typically includes a printer). The activity is represented in a single line graph which reflects the rhythm of the heart.

An irregular heart pattern, as reflected on an ECG or EKG, is an arrhythmia, and can be fatal.

There are approximately fifty or more different arrhythmias, each represented by a distinctive line graph pattern. These line graph patterns must be viewed and interpreted visually by a human being who is capable of recognizing the line patterns of the arrhythmias. Although it is possible to have a machine interpret ECG or EKG patterns, reading machines cannot view the patient and correlate the patient's physical status with the information on the ECG or EKG reading.

Electrocardiograph machines are highly sensitive machines which detect minute electrical impulses, changes and patterns. Thus, a number of readings that would indicate arrhythmias are disregarded or interpreted in light of the patient's observable physical status.

For example, it is a common scenario that a monitor disconnect from a monitoring device and register an ECG or EKG rhythm that indicates that the patient's heart has stopped (e.g., a ventricular rhythm or asystolic rhythm.) Other common problems occur when a patient is active, e.g., brushing his or her teeth, seizing, experiencing chills, shaking or simply moving normally.

Electrocardiograph systems typically have monitors or alarm systems that emit an audible sound to alert nursing and other healthcare professionals to check the status of a patient.

“Artifact” is a term known in the art which refers to data in an ECG or EKG record or image which falsely reflects an arrhythmia. Artifacts may be caused by normal patient activity, electrical interference and loose electrodes.

Medical staff, technicians, doctors, nurses and nurse practitioners must be trained to interpret ECGs and EKGs, both in the context of their graphical representations and the observable status of the patient. Interpretation of ECG's and EKG's graphical representations requires extensive training and visual memorization skills in order to memorize the line patterns. Many excellent nurses and physicians have difficulty quickly recognizing complex patterns of a single line, which is a skill required for recognizing an ECG or EKG pattern.

In emergency and high pressure situations, valuable time can be lost and deadly errors can be made as a result of misidentifying ECG's and EKG patterns.

Currently many companies produce visual cuing devices and flip charts. For example, Channing Bete Company and American Heart Association manufacture and distribute various templates, charts and books to be used by healthcare professionals as study and reference tools. However, these aids are not useful in actual patient monitoring settings. It is impractical for nurses to flip through books or look up fifty or more common arrhythmias while competently caring for patients.

Additionally, it is difficult for nurses and other healthcare professionals to efficiently monitor heart rhythms and reliably record them in a patient's chart. This means that valuable diagnostic data is lost. For example, it is cumbersome and time consuming for nurses to quickly (1) print out an ECG and EKG image which may reflect an arrhythmia; (2) label the document with the name of the arrhythmia that occurred; and (3) place the printout in the patient's electronic file.

In various medical monitoring environments (hospitals, clinics, long-term care centers, assisted living facilities, ambulances, flight for life, etc.), medical personnel of varying experience levels may be employed. Additionally, certain arrhythmias may present infrequently and are prone to misdiagnosis for this reason.

In hospital settings, dedicated technicians may be assigned to monitor electrocardiographic equipment; currently there is no way to monitor the accuracy and/or error rate of such personnel because their visual identification cannot be easily or economically recorded for spot-checking by supervisory personnel.

It is desirable to have a reliable system which allows a physician, nurse or technician to instantly recognize one of approximately 41 or more arrhythmias by name and communicate and/or document the rhythm and respond accordingly.

It is further desirable to efficiently capture ECG and EKG data over time intervals sufficient for diagnosis.

It is further desirable to continuously monitor the accuracy of professional staff in assessing and interpreting arrhythmias.

### SUMMARY OF THE INVENTION

The present invention is an emergency cardiac arrhythmia identifying device and system which can be implemented in a non-electronic visual media or in an electronic format capable of communicating ECG and EKG data observed by medical personnel over a local area network.

In the embodiment shown, a healthcare professional may visually identify an arrhythmia, record the occurrence of the arrhythmia in a specific patient file, communicate information to other healthcare professionals and view potential treatment protocols in a matter of seconds.

### DETAILED DESCRIPTION OF INVENTION

For the purpose of promoting an understanding of the present invention, references are made in the text to exemplary embodiments of an emergency cardiac arrhythmia identifying device and system, only some of which are described herein. It should be understood that no limitations on the scope of the invention are intended by describing these exemplary embodiments. One of ordinary skill in the art will readily appreciate that alternate but functionally equivalent electronic or non-electronic components and media may be used. The inclusion of additional elements may be deemed readily apparent and obvious to one of ordinary skill in the art. Specific elements disclosed herein are not to be interpreted as limiting, but rather as a basis for the claims and as a representative basis for teaching one of ordinary skill in the art to employ the present invention.

It should be understood that the drawings are not necessarily to scale; instead, emphasis has been placed upon illustrating the principles of the invention. In addition, in the embodiments depicted herein, like reference numerals in the various drawings refer to identical or near identical structural elements.

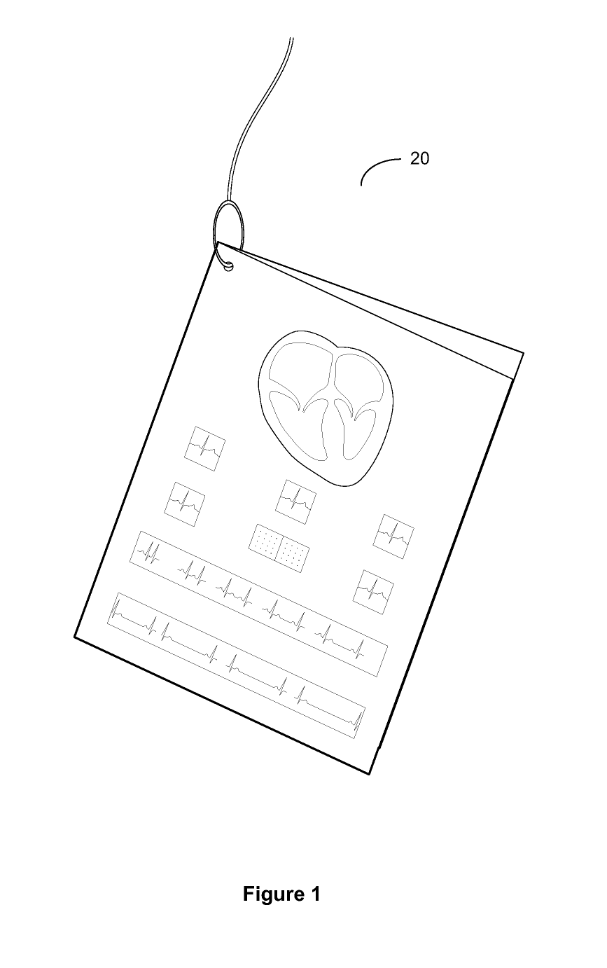

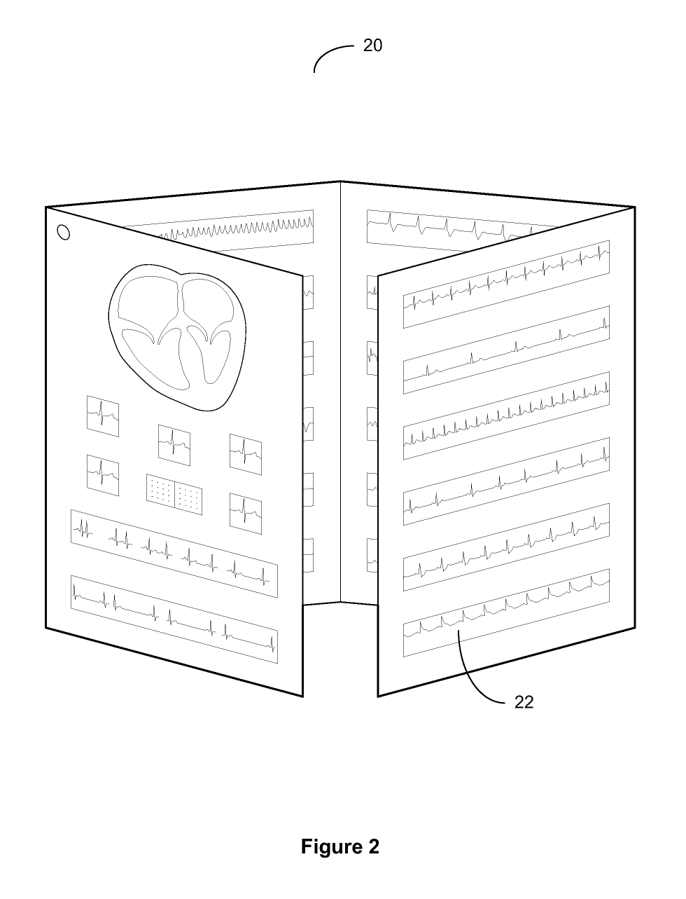

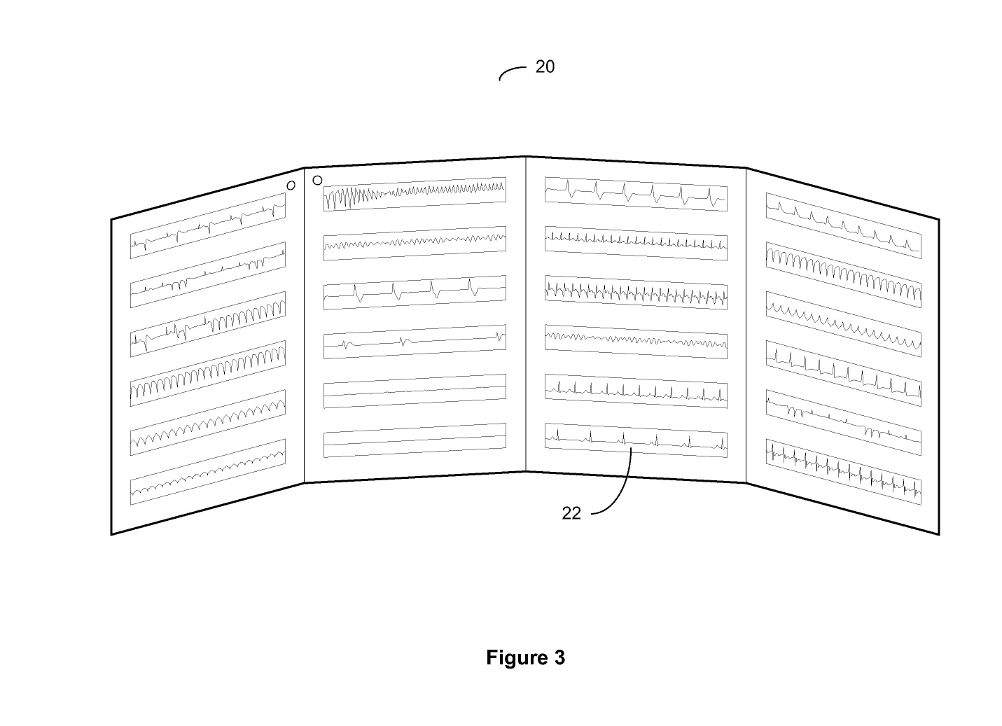

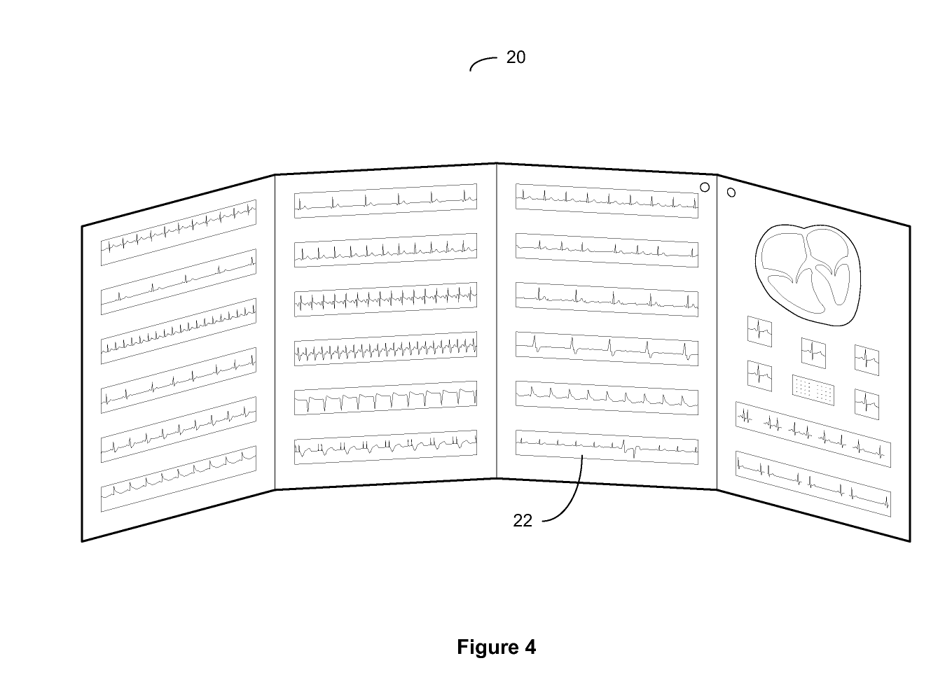

FIGS. 1 through 5 illustrate various views of an exemplary embodiment of an emergency cardiac arrhythmia identifying device 20. Emergency cardiac arrhythmia identifying device 20 contains a plurality of ECG/EKG arrhythmia images 22. In the exemplary embodiment shown in FIGS. 1-5, emergency cardiac arrhythmia identifying device 20 includes approximately forty-one images reflecting common ECG/EKG arrhythmia images 22 known in the art. Emergency cardiac arrhythmia identifying device 20 may also contain scaling, baseline or normative legend information.

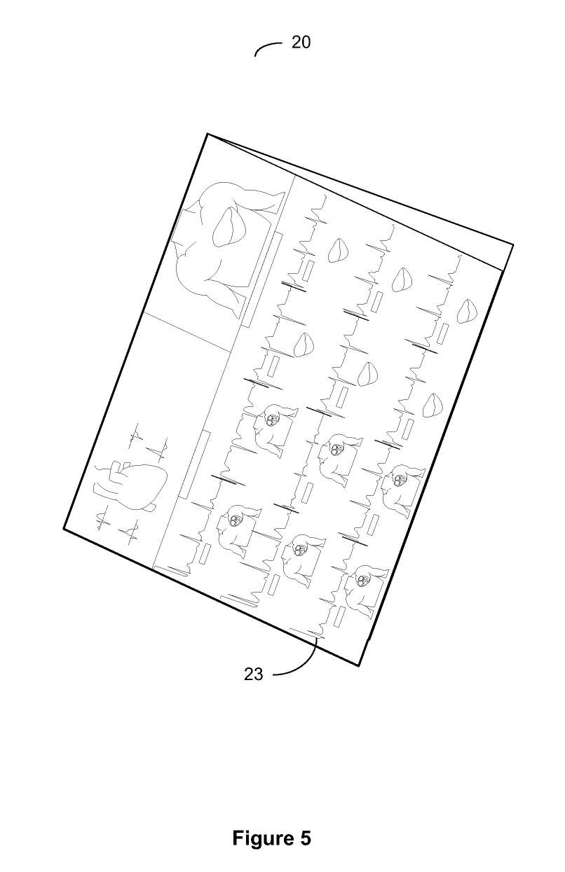

Various embodiments may include more or fewer ECG/EKG arrhythmia images 22. As illustrated in FIG. 5, further embodiments of emergency cardiac arrhythmia identifying device 20 may include “twelve lead” ECK/EKG arrhythmia images 23 known in the art and used to diagnose myocardial infarctions, ischemia, injury and other infarction. Still other embodiments may list instruction protocols indicating treatment options, contact options, medications and tests indicated, medication contraindications, tests which should be cancelled and any other medical protocol which may be known or established in the art for treating a particular arrhythmia pattern.

In the embodiment shown in FIGS. 1-5, ECG/EKG arrhythmia images 22 are shown of sufficient time duration to allow for identification of key characteristics of the arrhythmia pattern. ECG/EKG arrhythmia images 22 are also in the contrasting colors black on white to allow for quick visual identification. Red markings such as arrows or dashed lines may also be used to illustrate key characteristics of the arrhythmia. Key characteristics of the cardiac arrhythmias may also be described in writing on or near the specific ECG/EKG arrhythmia image 22. In further embodiments, the corresponding names of ECG/EKG arrhythmia images 22 are also provided in contrasting font colors. Corresponding names may also include established acronyms or abbreviations for ECG/EKG arrhythmias.

Other embodiments may list ECG/EKG arrhythmia images 22 in the order of treatment priority. In still further embodiments, ECG/EKG arrhythmia images 22 may be grouped according to similarity. In still further embodiments, ECG/EKG arrhythmia images 22 may be grouped so that commonly misidentified or confused ECG/EKG arrhythmias are grouped together for easy comparison.

In the embodiment shown in FIGS. 1-5, emergency cardiac arrhythmia identifying device 20 is adapted to be easily and quickly opened with one hand. In still further embodiments, emergency cardiac arrhythmia identifying device 20 may contain one or multiple pages, and may be of any shape or dimensions adapted to display, categorize or organize common ECG/EKG arrhythmia images 22 known in the art.

In the exemplary embodiment shown, emergency cardiac arrhythmia identifying device 20 is approximately the dimensions of a standard sheet of paper (8.5 inches by 11 inches) and easily adapted to be stored in a binder. In further embodiments, emergency cardiac arrhythmia identifying device 20 may be smaller or larger to accommodate different storage locations. For example, emergency cardiac arrhythmia device 20 may be smaller to fit in a pocket or larger to display as a poster on a wall.

In still other embodiments, emergency cardiac arrhythmia identifying device 20 may be laminated so that users may write on emergency cardiac arrhythmia identifying device 20 with a dry erase marker. Healthcare professionals or other users of emergency cardiac arrhythmia identifying device 20 may make notes or other observances on emergency cardiac arrhythmia identifying device 20 while comparing a patient's ECG/EKG strip to ECG/EKG arrhythmia images 22. Notes and observances may then be recorded in a patient's file before emergency cardiac arrhythmia identifying device 20 is wiped clean.

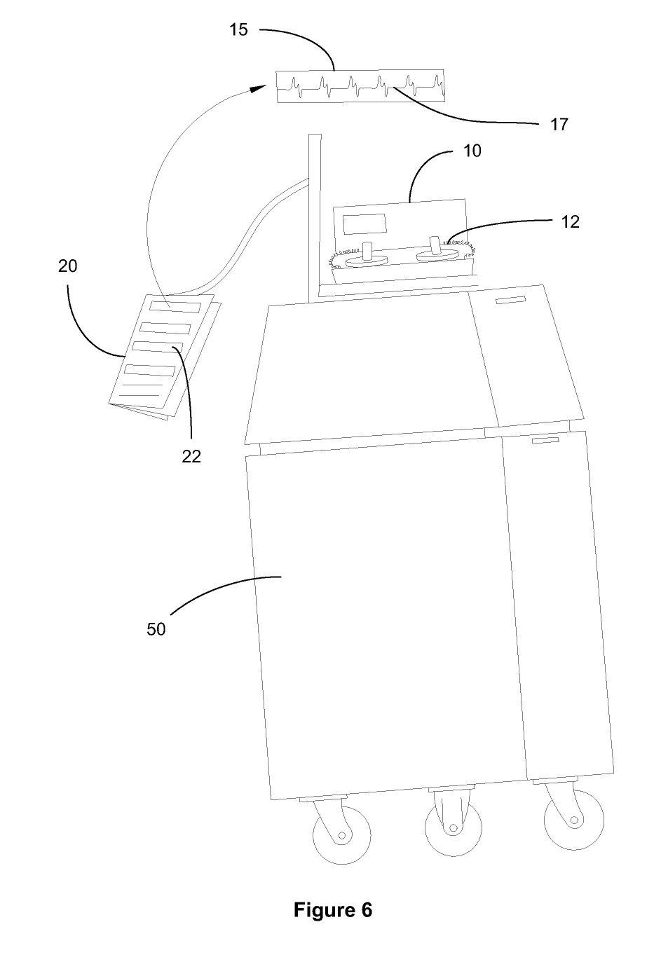

FIG. 6 is an exemplary system or embodiment of an emergency cardiac arrhythmia identifying device 20 in use with emergency crash cart 50 known in the art on which an electrograph device 10 is mounted. Electrograph device 10 includes printer 12 which prints an ECG/EKG “strip” 15 which is a paper rhythm/arrhythmia image 17 that is torn off and physically viewed by medical personnel who make a visual assessment of the patient and correlate rhythm/arrhythmia image 17 with their observation of the patient. (Medical staff may determine that a certain rhythm/arrhythmia image 17 may reflect artifact and/or machine error.)

In the embodiment shown, user compares images which are represented on ECG/EKG “strip” 15 with ECG/EKG arrhythmia images 22 for rapid visual identification.

In the embodiment shown, emergency cardiac arrhythmia identifying device 20 is shown attached to emergency crash cart 50. In various embodiments of the invention, emergency cardiac arrhythmia identifying device 20 may be attached by other means, including a pole, chain, clamp, cord, tethering device, lynch pin or any other attachment component or assembly known in the art. In further embodiments, emergency cardiac arrhythmia identifying device 20 may be three-hole punched to secure in a binder.

In still other embodiments, emergency cardiac arrhythmia identifying device 20 may be imprinted or affixed directly to emergency crash cart 50, or to a wall, table or any other accessible object.

In the embodiment shown, a healthcare professional may visually compare the images which are represented on ECG/EKG “strip” 15 with ECG/EKG arrhythmia images 22 of emergency cardiac arrhythmia identifying device 20.

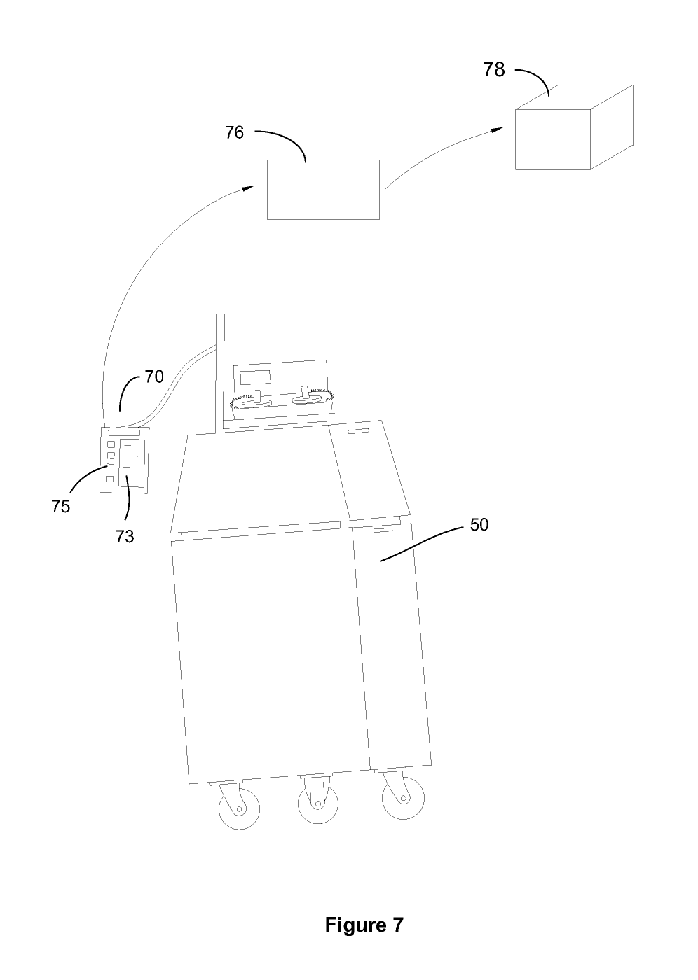

FIG. 7 illustrates one embodiment of an emergency cardiac arrhythmia identifying device implemented on a local area network, which includes electronic identifying component 70. Electronic identifying component 70 includes visual image component 73 which a user compares to ECG/EKG “strip” 15 (not shown). Visual image component 73 may be any electronic or paper interface which a user may compare visually to an ECG/EKG “strip” 15 (not shown) for rapid identification.

In various embodiments, visual image component 73 may have scrolling or indexing capability to display an optimum number of ECG/EKG arrhythmia images 22 (not shown) for rapid identification.

Other embodiments may include one or more selection buttons 75 which allow a user to select a display of ECG/EKG arrhythmia images when a match has been made to ECG/EKG “strip” 15. In various embodiments, selection buttons 75 may record the match, send electronic message 76 to an electronic patient file contained in patient file database 78 or medical staff member and/or prompt a display of potential treatments or protocols.

Still other embodiments of electronic identifying component 70 may include one or more visual image components, such as a drop down menu selection option that allows a healthcare professional to rapidly select a pattern.

In the embodiment shown, a healthcare professional may visually identify an arrhythmia, record the occurrence of the arrhythmia in a specific patient file, communicate information to other healthcare professionals and view treatment protocols in a matter of seconds.

What is claimed is:

1. A visual cuing device for heart arrhythmias comprising:
a rigid display having an upper surface and a lower surface each divided into a plurality of panels having a series of contrasting color bands; and
said upper surface and lower surface each configured to display a plurality of ECG/EKG arrhythmia images and corresponding names representing diagnosable cardiac arrhythmias, each of said ECG/EKG arrhythmia images displayed of sufficient time duration to allow identification of said cardiac arrhythmia.

2. The visual cuing device of claim 1 which further includes reinforced pivoting seam lines to allow folding.

3. The visual cuing device of claim 2 in which said rigid display is of sufficient rigidity so that said rigid display remains closed when folded along said reinforced pivoting seam lines without securing devices.

4. The visual cuing device of claim 1 wherein said plurality of ECG/EKG arrhythmia images are chosen from a group consisting of Normal sinus rhythm, Sinus bradycardia, Sinus tachycardia, Sinus arrhythmia, Sinus with ST depression, Sinus with ST elevation, Sinus rhythm with significant Q-wave, Sinus with wide QRS and inverted T-wave, Sinus arrest, Atrial tachycardia, Sinus with paroxysmal superventricular tachycardia, Wolf Parkinson White Syndrome, Atrial flutters, Artifact, Atrial fibrillation, Multi Atrial tachycardia, Sinus with premature atrial contractions, Sinus with premature junctional contractions, Junctional escape rhythm, Accelerated junctional rhythm, Atrial pacing, Ventricular pacing, Ventricular pacing with failure to capture, atrial ventricular pacing, 1st degree heart block, 2nd degree type I, 2nd degree type II, 3rd degree heart block (complete heart block), 3rd degree AV block with junctional escape pacemaker, Sinus with unifocal premature ventricular contractions, Sinus with multi-focal premature ventricular contractions, Sinus with episodes of non-sustained ventricular tachycardia, Sinus with premature ventricular contractions converting to ventricular tachycardia (R on T), Sustained ventricular tachycardia, Tor sades de pointe, Ventricular fibrillation, Idioventricular rhythm, Accelerated idioventricular rhythm, Agonal rhythm (dying heart), and Ventricular standstill progressing to asystole.

5. The visual cuing device of claim 1 wherein said upper surface and said lower surface are further configured to display potential treatments for at least one cardiac arrhythmia.

6. The visual cuing device of claim 1 which is further adapted to include textual descriptions of key characteristics for at least one cardiac arrhythmia in a font size no smaller than 7 point.

7. The visual cuing device of claim 1 wherein said plurality of ECG/EKG arrhythmia images are arranged in order of treatment priority.

8. The visual cuing device of claim 1 wherein said plurality of ECG/EKG arrhythmia images are grouped according to similarity.

9. The visual cuing device of claim 1 wherein said plurality of ECG/EKG arrhythmia images are arranged so that commonly misidentified arrhythmias are grouped together for easy comparison.

10. The visual cuing device of claim 1 wherein said upper surface and said lower surface are further configured to display twelve lead ECK/EKG arrhythmia images.

11. The visual cuing device of claim 1 wherein said rigid display is secured to a surface by a means chosen from a group consisting of a pole, chain, clamp, cord, tethering device, and lynch pin.

12. The visual cuing device of claim 1 in which said plurality of panels have dimensions ranging from 3 inches by 5 inches to 30 inches by 40 inches.

13. The visual cuing device of claim 1 wherein each of said plurality of panels are adapted to contain six of said ECG/EKG arrhythmia images.

14. The visual cuing device of claim 1 in which said plurality of ECG/EKG arrhythmia images are black on white.

15. The visual cuing device of claim 1 wherein said corresponding names are written in a first color with select letters corresponding to established acronyms for cardiac arrhythmias in a second color on a contrasting third colored background.

16. The visual cuing device of claim 1 wherein said corresponding names are in a size font between 12 point and 18 point.

17. The visual cuing device of claim 1 which is further adapted to be written on with a dry erase marker.

18. The visual cuing device of claim 1 wherein said plurality of ECG/EKG arrhythmia images are further adapted for alignment with actual ECG/EKG strips.

19. A visual cuing device for heart arrhythmias comprising:
an electronic identifying component;
an index of ECG/EKG arrhythmia images accessible by said electronic identifying component; and
a user interface adapted to visually display at least one ECG/EKG arrhythmia image from said index.

20. The visual cuing device of claim 20 wherein said user interface is further adapted with a scrolling function to allow a user to chose at least one ECG/EKG arrhythmia image from said index to display on said user interface.

21. The visual cuing device of claim 20 wherein said electronic identifying component is further adapted to communicate with electronic patient files over a local area network, and said user interface is further adapted to allow a user to send electronic messages to said electronic patient files.

22. A method of making a visual cuing apparatus for heart arrhythmias comprising the steps of:
obtaining a pattern for a heart rhythm;
identifying said heart rhythm;
creating exemplary image data characteristic of said heart rhythm;
grouping heart rhythms according to treatment priority; and
arranging rhythms in rapid identification formatting.
